(19) United States
(12) Patent Application Publication
(10) Pub. No.: US 2026/0325899 A1
(43) Pub. Date: Oct. 22, 2026

(54) Fire Retardant Formulations and Methods of Use

(71) Applicant: NATURAL ALTERNATIVES, LLC, Lexington, KY (US)

(72) Inventor: Todd Bloomer, Lexington, KY (US)

(21) Appl. No.: 19/108,893

(22) PCT Filed: Sep. 6, 2023
(86) PCT No.: PCT/US2023/032069

§ 371 Date: Mar. 5, 2025

(30) Foreign Application Priority Data
Sep. 6, 2022 (US) 63404025

(51) Int. Cl. A62D 1/00; A62C 3/02

(52) U.S. Cl. CPC A62D 1/0042; A62C 3/02; A62D 1/005

(57) ABSTRACT

A fire retardant formulation includes a first flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof and a second agent selected from a group consisting of a flame retardant colorant, an additional flame retardant agent and mixtures thereof. A method of suppressing a wild fire or forest fire includes the step of applying an effective amount of the fire retardant formulation to (a) the wild fire, (b) the forest fire, (c) an area to be protected from the wild fire or the forest fire or (d) combinations thereof.

### RELATED APPLICATIONS

This document claims priority to U.S. Provisional Patent Application Ser. No. 63/404,025, filed on Sep. 6, 2022, which is hereby incorporated by reference.

### TECHNICAL FIELD

This document relates generally to fire retardant and fire suppressant compositions and formulations as well as to related methods of controlling forest fires and wild fires.

### BACKGROUND

Fire retardants have been used for over 60 years to (a) suppress and decrease the intensity of forest and wild fires, (b) to protect property when threatened by fire and (c) to assist ground crews to extinguish forest fires and wild fires. This document relates to new and improved fire retardant formulations that are made from natural, environmentally friendly materials that exhibit notable flame retardant properties.

### SUMMARY

In accordance with the purposes and benefits set forth herein, a new and improved fire retardant formulation is provided. That formulation comprises, consists of or consists essentially of: (a) a first flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof and (b) a second agent selected from a group consisting of a flame retardant colorant, an additional flame retardant agent and mixtures thereof.

In one or more of the many useful embodiment, the first flame retardant agent is characterized by having a viscosity of about 25 secs with a Zahn #2 cup and a pH of about 6.8 to about 9.7. The first flame retardant agent may have a solids content of between about 1% and about 80%.

In one or more of the many possible embodiments, the first flame retardant agent of the formulation further includes (a) a surfactant, (b) an emulsifier, (c) a viscosity modifier or (d) combinations thereof. The surfactant may be selected from a group consisting of an anionic surfactant, a cationic surfactant, a non-ionic surfactant, a amphoteric surfactant and combinations thereof. In at least one possible embodiment, the surfactant is a polyethylene glycol ester surfactant.

The emulsifier may be selected from a group of emulsifiers consisting of a polysorbate, canola oil, lecithin, glycerin and combinations thereof. The viscosity modifier may be selected from a group consisting of a cellulose gel, a formate, an acetate, an organic acid and combinations thereof.

In some particularly useful embodiments, the first flame retardant agent of the fire retardant formulation is characterized by pectin levels reduced below naturally occurring levels. More specifically, in some embodiments, the pectin levels of the first flame retardant agent are reduced below 0.1 weight percent of the first flame retardant agent. In still other embodiments, the pectin levels of the first flame retardant agent are reduced below 0.08 weight percent of the first flame retardant agent.

In some embodiments, the flame retardant colorant is a dye. In some embodiments, the flame retardant colorant is a fugitive dye that breaks down over time with UV light exposure.

In some embodiments, the flame retardant colorant is iron oxide. In some embodiments, the additional flame retardant is selected from a group consisting of solutions of ammonium phosphate fertilizer, chloride salts, magnesium chloride and mixtures thereof.

In accordance with an additional aspect, a new and improved method of suppressing a wild fire or forest fire is provided. That method comprises, consists of or consists essentially of applying an effective amount of the fire retardant formulation described above to (a) the wild fire, (b) the forest fire, (c) an area to be protected from the wild fire or the forest fire or (d) combinations thereof. In accordance with yet another aspect, a new and improved method of suppressing a wild fire or forest fire, comprises, consists of or consists essentially of applying an effective amount of a flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof.

In the following description, there are shown and described several different embodiments of the new and improved fire retardant formulation and related method of suppressing a wild fire or forest fire. As it should be realized, the formulation and method are capable of other, different embodiments and their several details are capable of modification in various, obvious aspects all without departing from the formulation and method as set forth and described in the following claims. Accordingly, the descriptions should be regarded as illustrative in nature and not as restrictive.

### DETAILED DESCRIPTION

A new and improved fire retardant formulation may be generally described as comprising, consisting of or consisting essentially of: (a) a first flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof and (b) a second agent selected from a group consisting of a flame retardant colorant, an additional flame retardant agent and mixtures thereof. The first flame retardant agent may have a viscosity of about 25 secs with a Zahn #2 cup and a pH of about 6.8 to about 9.7. The first flame retardant agent may have a solids content of between about 1% and about 80% and, more typically, between about 40% and about 60% for best performance and cost. Some embodiments have a solids content of about 50%.

The first flame retardant agent may comprise as little as 0.01% or as much as 99.9% by volume of the flame retardant formulation. Additional water may be added. Mixtures can be blended and applied as needed for equipment usage. Normally aerial application material cannot weigh more than 9.3 pounds per gallon. Mixtures can also be blended to lessen environmental impact by using higher dilutions of water, the neet formula or the blended formula.

The formulation may be made by blending the neet solution with water, glycerin, a formate, or acetate and adding water to reduce the viscosity. The formulation will have the capabilities of sticking to and coating natural areas to which it is applied. The formulation will have the characteristics of being able to be pumped in cold weather and being able to stick in warmer weather.

Materials useful in the first flame retardant agent, including the admixtures of desugared sugar beet molasses, include, but are not necessarily limited to, surfactants, emulsifiers, and viscosity modifiers as well as combinations thereof. Surfactants that may be used in the formulation include, but are not necessarily limited to anionic, cationic, non-ionic, amphoteric and combinations thereof. This includes, but is not necessarily limited to, polyethylene glycol ester surfactants.

Emulsifiers can also be useful in the admixtures of the desugared sugar beet molasses. Emulsifiers function to increase the efficiency of the solutions which allows for easier handling especially when its cold. Emulsifiers useful in the formulations include, but are not necessarily limited to polysorbates, canola oil, lecithin, glycerin and combinations thereof.

Viscosity modifiers useful to lower the viscosity and improve the handling and spraying properties of the formulations include, but are not necessarily limited to cellulose gels, formates, acetates, organic acids (e.g. citric) and combinations thereof.

Sugar beet pulp upon sugar extraction consists of up to 15-30% pectin (dry basis). Pectin, a soluble gelatinous polysacharride, has been found in some instances to adversely effect the coating properties of the flame retardant composition. Accordingly, in some embodiments of the flame retardant formulations, the pectin levels of the first flame retardant agent are reduced below naturally occurring levels. More particularly, in some embodiments the pectin levels of the first flame retardant agent are reduced below 0.1 weight percent of the first flame retardant agent. In still other embodiments, the pectin levels of the first flame retardant agent are reduced below 0.08 weight percent of the first flame retardant agent. This may be done by processing known to those skilled in the art to improve the coating properties of the product.

Additional flame retardants agents useful in the formulation include known flame retardant gels and foams. These include, but are not necessarily limited to solutions of ammonium phosphate fertilizers such as Phos-Chek® 259F, Phos-Chek® D-75F, Phos-Chek® AquaGel K, Thermo_Gel® 200L, Phos-Chek® WD88, chloride salts, magnesium chloride and mixtures thereof. Many state-of-the-art flame retardants, such a chloride salts and magnesium chloride, have corrosive properties that are detrimental to the longevity and performance of firefighting equipment. Advantageously, the first flame retardant agent exhibits anticorrosive properties thereby alleviating this concern.

The flame retardant formulation may also include a colorant at an effective amount to aid in readily identifying areas treated with the flame retardant composition. Known flame retardant colorants include dyes, including, but not necessarily limited to “fugitive dyes” that break down over time with UV light exposure. One such fugitive dye is iron oxide which provides a bright red color to the formulation. Further, the flame retardant composition may include one or more corrosion inhibitors, stabilizers and bactericides known to be useful in flame retardant compositions.

In accordance with an additional aspect, a method of suppressing a wild fire or forest fire comprises the step of applying an effective amount of the fire retardant formulation to: (a) the wild fire, (b) the forest fire, (c) an area to be protected from the wild fire or forest fire and (d) a combination of the above. A method of suppressing a wild fire or forest fire, may also comprise applying an effective amount of a flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof. The fire retardant formulation or the flame retardant agent may be applied by ground personnel or by dropping from fixed or rotary-wing aircraft in a manner known in the art.

This disclosure may be said to relate to the following items.
1. A fire retardant formulation, comprising:
   a first flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof; and
   a second agent selected from a group consisting of a flame retardant colorant, an additional flame retardant agent and mixtures thereof.
2. The flame retardant formulation of item 1, wherein the first flame retardant agent has a viscosity of about 25 secs with a Zahn #2 cup and a pH of about 6.8 to about 9.7.
3. The flame retardant formulation of item 1, wherein the first flame retardant agent has a solids content of between about 1% and about 80%.
4. The flame retardant formulation of item 1, wherein the first flame retardant agent further includes (a) a surfactant, (b) an emulsifier, (c) a viscosity modifier or (d) combinations thereof.
5. The formulation of item 4, wherein the surfactant is selected from a group consisting of an anionic surfactant, a cationic surfactant, a non-ionic surfactant, a amphoteric surfactant and combinations thereof.
6. The formulation of item 4, wherein the surfactant is a polyethylene glycol ester surfactant.
7. The formulation of item 4, wherein the emulsifier is selected from a group of emulsifiers consisting of a polysorbate, canola oil, lecithin, glycerin and combinations thereof.
8. The formulation of item 4, wherein the viscosity modifier is selected from a group consisting of a cellulose gel, a formate, an acetate, an organic acid and combinations thereof.
9. The formulation of item 4, wherein pectin levels of the first flame retardant agent are reduced below naturally occurring levels.
10. The formulation of item 4, wherein pectin levels of the first flame retardant agent are reduced below 0.1 weight percent of the first flame retardant agent.
11. The formulation of item 4, wherein pectin levels of the first flame retardant agent are reduced below 0.08 weight percent of the first flame retardant agent.
12. The formulation of item 1, wherein pectin levels of the first flame retardant agent are reduced below naturally occurring levels.
13. The formulation of item 1, wherein pectin levels of the first flame retardant agent are reduced below 0.1 weight percent of the first flame retardant agent.
14. The formulation of item 1, wherein pectin levels of the first flame retardant agent are reduced below 0.08 weight percent of the first flame retardant agent.
15. The formulation of item 1, wherein the flame retardant colorant is a dye.
16. The formulation of item 1, wherein the flame retardant colorant is a fugitive dye that breaks down over time with UV light exposure.
17. The formulation of item 1, wherein the flame retardant colorant is iron oxide.
18. The formulation of item 1, wherein the additional flame retardant is selected from a group consisting of solutions of ammonium phosphate fertilizer, chloride salts, magnesium chloride and mixtures thereof.
19. A method of suppressing a wild fire or forest fire, comprising: applying an effective amount of the fire retardant formulation of claim 1 to (a) the wild fire, (b) the forest fire, (c) an area to be protected from the wild fire or the forest fire or (d) combinations thereof.
20. A method of suppressing a wild fire or forest fire, comprising: applying an effective amount of the fire retardant formulation of claim 9 to (a) the wild fire, (b) the forest fire, (c) an area to be protected from the wild fire or the forest fire or (d) combinations thereof.
21. A method of suppressing a wild fire or forest fire, comprising: applying an effective amount of a flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a surfactant”, as used herein, may also refer to, and encompass, a plurality of surfactants.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10 % of the stated numerical value.

Although the formulation and related method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A fire retardant formulation, comprising:
a first flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof; and
a second agent selected from a group consisting of a flame retardant colorant, an additional flame retardant agent and mixtures thereof.

2. The flame retardant formulation of claim 1, wherein the first flame retardant agent has a viscosity of about 25 secs with a Zahn #2 cup and a pH of about 6.8 to about 9.7.

3. The flame retardant formulation of claim 1, wherein the first flame retardant agent has a solids content of between about 1% and about 80%.

4. The flame retardant formulation of claim 1, wherein the first flame retardant agent further includes (a) a surfactant, (b) an emulsifier, (c) a viscosity modifier or (d) combinations thereof.

5. The formulation of claim 4, wherein the surfactant is selected from a group consisting of an anionic surfactant, a cationic surfactant, a non-ionic surfactant, a amphoteric surfactant and combinations thereof.

6. The formulation of claim 4, wherein the surfactant is a polyethylene glycol ester surfactant.

7. The formulation of claim 4, wherein the emulsifier is selected from a group of emulsifiers consisting of a polysorbate, canola oil, lecithin, glycerin and combinations thereof.

8. The formulation of claim 4, wherein the viscosity modifier is selected from a group consisting of a cellulose gel, a formate, an acetate, an organic acid and combinations thereof.

9. The formulation of claim 4, wherein pectin levels of the first flame retardant agent are reduced below naturally occurring levels.

10. The formulation of claim 4, wherein pectin levels of the first flame retardant agent are reduced below 0.1 weight percent of the first flame retardant agent.

11. The formulation of claim 4, wherein pectin levels of the first flame retardant agent are reduced below 0.08 weight percent of the first flame retardant agent.

12. The formulation of claim 1, wherein pectin levels of the first flame retardant agent are reduced below naturally occurring levels.

13. The formulation of claim 1, wherein pectin levels of the first flame retardant agent are reduced below 0.1 weight percent of the first flame retardant agent.

14. The formulation of claim 1, wherein pectin levels of the first flame retardant agent are reduced below 0.08 weight percent of the first flame retardant agent.

15. The formulation of claim 1, wherein the flame retardant colorant is a dye.

16. The formulation of claim 1, wherein the flame retardant colorant is a fugitive dye that breaks down over time with UV light exposure.

17. The formulation of claim 1, wherein the flame retardant colorant is iron oxide.

18. The formulation of claim 1, wherein the additional flame retardant is selected from a group consisting of solutions of ammonium phosphate fertilizer, chloride salts, magnesium chloride and mixtures thereof.

19. A method of suppressing a wild fire or forest fire, comprising: applying an effective amount of the fire retardant formulation of claim 1 to (a) the wild fire, (b) the forest fire, (c) an area to be protected from the wild fire or the forest fire or (d) combinations thereof.

20. A method of suppressing a wild fire or forest fire, comprising: applying an effective amount of the fire retardant formulation of claim 9 to (a) the wild fire, (b) the forest fire, (c) an area to be protected from the wild fire or the forest fire or (d) combinations thereof.

21. A method of suppressing a wild fire or forest fire, comprising: applying an effective amount of a flame retardant agent consisting of desugared sugar beet molasses, admixtures of desugared sugar beet molasses exhibiting flame retardant properties, desugared sugar cane molasses, admixtures of desugared sugar cane molasses exhibiting flame retardant properties, concentrated molasses solids (CMS), concentrated bypass syrup (CBS), concentrated syrup byproduct (CSB), raffinate, potassium acetate, glycerin, sugar cane molasses, sugar beet molasses and mixtures thereof.
